(19) United States
(12) Patent Application Publication
(10) Pub. No.: US 2006/0099355 A1
(43) Pub. Date: May 11, 2006

(54) Method of making a foamed polymeric material

(76) Inventor: Julie Baker, Leavesden (GB)

Correspondence Address: BETH READ;PATENT LEGAL STAFF, EASTMAN KODAK COMPANY, 343 STATE STREET, ROCHESTER, NY, 14650-2201, US

(21) Appl. No.: 10/545,406

(22) PCT Filed: Jan. 23, 2004
(86) PCT No.: PCT/GB04/00292

§ 371 Date: Aug. 10, 2005

(30) Foreign Application Priority Data
Feb. 13, 2003 (GB) 03032612

(51) Int. Cl. B41M 5/00

(52) U.S. Cl. 428/32.1

(57) ABSTRACT

A method of making a material comprising the steps of coating a support with at least one layer of polymer solution containing a surfactant and a blowing agent. The pH value of the solution is reduced prior to the addition of the blowing agent resulting in a smoother surface to the material.

### FIELD OF THE INVENTION

This invention relates to a method of making a material, in particular to a method of making a foamed polymeric material suitable for use as an inkjet printing medium.

### BACKGROUND OF THE INVENTION

Inkjet printing is a process in which a stream of ink, preferably in the form of droplets, is ejected at high speed from nozzles against a medium so as to create an image.

Media used for inkjet recording need to be dimensionally stable, absorptive of ink, capable of providing a fixed image and compatible with the imaging materials and hardware.

Most commercial photo quality inkjet media can be classified in one of two categories according to whether the principle component material forms a layer that is porous or non porous in nature. Inkjet media having a porous layer are typically formed of inorganic materials with a polymeric binder. When ink is applied to the medium it is absorbed into the porous layer by capillary action. The ink is absorbed very quickly but the open nature of the porous layer can contribute to the instability of printed images, particularly when the images are exposed to environmental gases such as ozone.

Inkjet media which have a non porous layer are typically formed of one or more polymeric layers that swell and absorb the applied ink. Due to the limitations of the swelling mechanism this type of media is slow to absorb the ink. However, once dry the printed images are often stable when subjected to light and ozone.

Alternatives to pure “porous” or “non porous” media are hybrids which take the merits of each pure medium. These hybrids have swellable porous layers. One such media is created from foamed polymer layers using a swellable hydrophilic polymer and blowing agents. This results in the formation of voids in the polymer layer which lead to improved absorption of the ink. Instead of the ink being held in pores which are located in-between particles, as in conventional porous media, the ink is located within the polymer. This results in improved image stability.

GB 0218505.6 discloses an inkjet printing medium formed by a foamed polymeric layer. This medium may be created by the use of blowing agents.

GB 0223835.0 and GB 0226309.3 also disclose an inkjet printing medium formed from a foamed polymeric layer.

### PROBLEM TO BE SOLVED BY THE INVENTION

It has been found that if the pH value of the polymer solution, i.e. the melt, is left unadjusted the surface of the inkjet media is quite rough.

It is an aim of the invention to provide a method of improving the surface characteristics of a foamed polymeric material.

It has been found that significantly smoother surfaces can be achieved by either reducing the pH value of the melt before the blowing agents are added or by dual melting the blowing agents into a layer in which the pH value has been reduced.

### SUMMARY OF THE INVENTION

According to the present invention there is provided a method of making a material comprising the steps of coating a support with at least one layer of polymer solution containing a surfactant, and at least one blowing agent, the pH value of the at least one layer of solution being reduced prior to the addition of the at least one blowing agent. Preferably the pH is reduced to 4 or below, more preferably the pH is reduced to within the range of pH 2 to pH 4.

The invention further provides a material formed by the method as described above.

### ADVANTAGEOUS EFFECT OF THE INVENTION

The present invention provides a method of making an inkjet media or similar material having a porous hydrophilic polymer layer with improved surface characterstics. Significantly smoother surfaces can be achieved with the method of the invention.

### BRIEF DESCRIPTION OF THE DRAWINGS

The invention will now be described, by way of example, with reference to the accompanying drawings, in which:

FIG. 1 is a scanning electron micrograph of a section through an inkjet media showing the bubble formation in an ink receiving layer formed with coating A as described below;

FIG. 2 is a scanning electron micrograph of a section through an inkjet media showing the bubble formation in an ink receiving layer formed with coating C as described below;

FIG. 3 is a scanning electron micrograph of a section through an inkjet media showing the bubble formation in an ink receiving layer formed with coating D as described below; and

FIG. 4 is a scanning electron micrograph of a section through an inkjet media showing the bubble formation in an ink receiving layer formed with coating E as described below.

FIG. 5 is a scanning electron micrograph of a section through an inkj et media showing the bubble formation in an ink receiving layer formed with coating F as described below.

### DETAILED DESCRIPTION OF THE INVENTION

The present invention provides a method of making a material. The material may have many different uses, including use as an inkjet medium

The medium comprises a support layer, such as resin coated paper, PET film base, acetate, printing plate or any other suitable support, and one or more polymeric layers supported on the support layer.

The at least one polymeric layer comprises a hydrophilic polymer. Examples could include polyvinyl alcohol, polyethylene oxide, polyvinyl pyrrolidone and gelatin

The at least one polymeric layer is created by the use of blowing agents. Examples of suitable blowing agents include a mixture of sodium nitrite and ammonium chloride, metal carbonates and bicarbonates. Further examples of suitable blowing agents are described in, for example, the Handbook of Polymeric Foams and Foam Technology, edited by Daniel Klempner and Kurt C. Frisch, Chapter 17: Blowing Agents for Polymer Foams, Section 3 Chemical Blowing Agents (chapter written by Dr. Fyodor A. Shutov). Heat causes the blowing agents to decompose and create gas bubbles within the solution which causes foaming of the polymer. The foam is effectively a network of either open or closed cell arrangements of voids within a polymer matrix. Full details of such an inkjet medium are disclosed in UK patent application GB 0218505.6.

It has been found that if the pH value of the melt containing the surfactants is left unadjusted the surface of the final coating is quite rough. If however the pH of the melt is dropped before the blowing agents are added or the blowing agents are dual melted into a layer in which the pH has been reduced the surface roughness of the final coating is significantly reduced.

In a preferred embodiment of the invention, the pH is reduced to a value of 5 or below, for example to about pH 2 or about pH 4 or to a pH in the range from 2 to 5. More preferably, the pH is reduced to a value of 4 or below, still more preferably to a pH value in the range 2 to 4.

In a further aspect of the invention, there is provided an ink-receiving layer for an inkjet receiver, said ink-receiving layer obtainable by the method described above.

### EXAMPLES

A resin coated paper support was coated on the front with three ink receiving layers. Each layer comprised polyvinyl alcohol (PVA) and some surfactant. Blowing agents were either added to each layer at a rate of 50 wt % with respect to the PVA laydown of that layer or dual melted into the top layer at the coating point at a rate of 50 wt % compared to the total PVA laydown of the coating.

In the first examples, (coating A and coating B), the ink-receiving layer nearest the support consisted of 5.0 g/m² of PVA, 1.41 μm² of sodium nitrite, 1.09 g/m² of ammonium chloride and 0.106 g/m² of surfactant. The middle ink-receiving layer consisted of 5.7 g/m² of PVA, 1.61 g/m² of sodium nitrite, 1.24 g/m² of ammonium chloride and 0.212 g/m² of surfactant The top ink-receiving layer consisted of 6.9 g/m² of PVA, 1.94 g/m² of sodium nitrite, 1.51 g/m² of ammonium chloride and 0.318 g/m² of surfactant. Therefore the total PVA laydown of the entire coating pack was 17.6 g/m² and the total laydown of the blowing agents was 8.8 g/m².

For coating A, the pH of the melts was adjusted down to pH 4.0 with sulphuric acid before the sodium nitrite and ammonium chloride were added.

For coating B, the pH of the melts was left unadjusted at pH 6.0. Coating B is a control coating.

The three layers were then coated simultaneously on a bead-coating machine using a standard slide hopper.

In the next examples, (coating F, coating C, coating D and coating E), the ink-receiving layer nearest the support consisted of 5.7 g/m² of PVA and 0.106 g/m² of surfactant. The middle ink-receiving layer consisted of 6.5 g/m² of PVA and 0.212 g/m² of surfactant The top ink-receiving layer consisted of 5.4 g/m² of PVA and 0.318 g/m² of surfactant.

For coating F the pH of the melts was adjusted to pH 2.0 using sulphuric acid

For coating C the pH of the melts was adjusted to pH 4.0 using sulphuric acid.

For coating D the pH of the melts was adjusted to pH 5.0 using sulphuric acid.

For coating E the pH of the melts was left unadjusted at pH 6.0.

For each coating the blowing agents were then dual melted into the top ink receiving layer. The 40% sodium nitrite solution was dual melted using a laydown of 12.4 mls/m² (which is equivalent to 4.96 g/m² of sodium nitrite). The 20% ammonium chloride solution was dual melted using a laydown of 19.2 mls/m² (which is equivalent to 3.84 g/m² of ammonium chloride). Therefore the total PVA laydown of the entire coating pack was 17.6 g/m² and the total laydown of the blowing agents was 8.8 g/m² i.e. the same as for coating A and coating B. The three layers were then coated simultaneously on a bead-coating machine using a standard slide hopper

To initiate the blowing process the dryers inside the coating track were set to 90° C. Each of the coatings passed through the dryers.

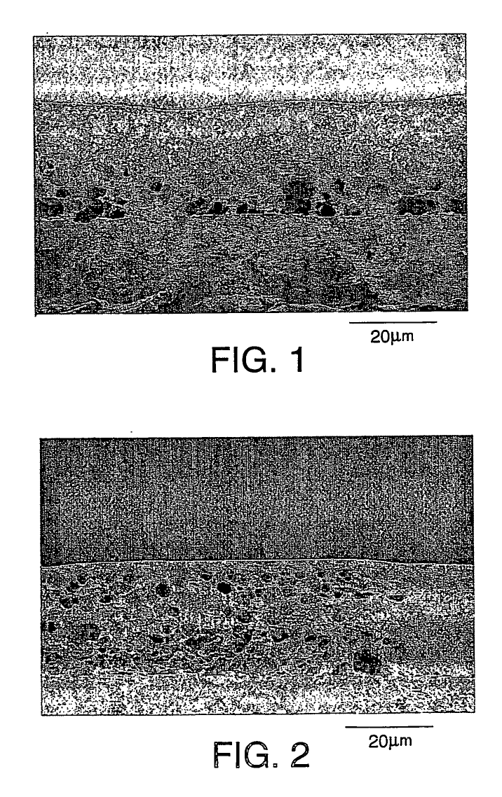

FIGS. 1, 2, 3, 4 and 5 show that the bubble formation is unaffected by either the pH of the melt or the method of addition of the blowing agent

FIG. 1 shows coating A where the melt pH was adjusted to pH 4 and the blowing agents were added directly to the melts.

FIG. 2 shows coating C where the melt pH was adjusted to pH 4 and the blowing agents were dual melted into the top ink receiving layer at the hopper.

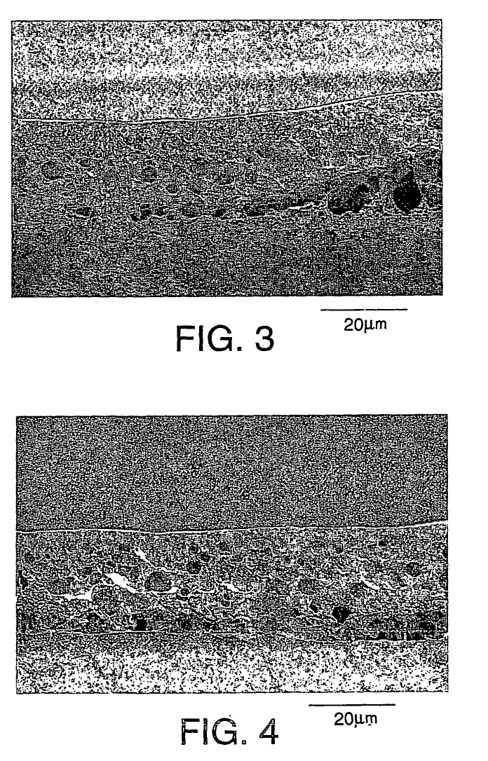

FIG. 3 shows coating D where the melt pH was adjusted to pH 5 and the blowing agents were dual melted into the top ink receiving layer at the hopper.

FIG. 4 shows coating E where the melt pH was left unadjusted at pH 6 and the blowing agents were dual melted into the top ink receiving layer at the hopper.

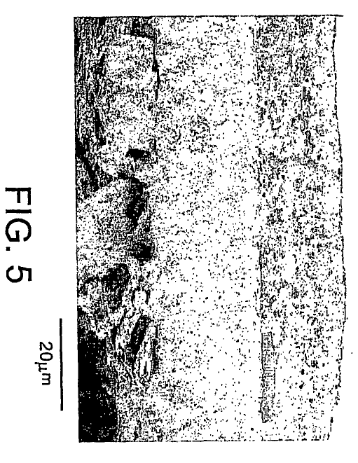

FIG. 5 shows coating F where the melt pH was adjusted to pH 2 and the blowing agents were dual melted into the top ink receiving layer at the hopper.

The table below shows the surface roughness measurements from all of the coatings.

| | Blowing Agent | | Rt | Rz | Rpm |
|---|---|---|---|---|---|
| Coating | Addition Method | Melt pH | (μm) | (μm) | (μm) |
| A | Added to pots | 4 | 29.90 | 27.65 | 20.59 |
| B | Added to pots | 6 | 40.85 | 34.84 | 27.74 |
| F | Dual Melted | 2 | 18.06 | 16.87 | 7.79 |
| C | Dual Melted | 4 | 23.69 | 19.77 | 11.30 |
| D | Dual Melted | 5 | 28.86 | 23.63 | 12.46 |
| E | Dual Melted | 6 | 35.19 | 27.44 | 14.45 |

Rt = Maximum value from peak to valley
Rz = Average peak to valley height
Rpm = Average height

From the data in the table above it can be seen that the pH of the melt has a significant effect on surface roughness. Irrespective of whether the blowing agents are added directly to the melts or dual melted into the top layer at the coating point, significantly smoother surfaces are achieved when the pH of the melt is reduced from pH 6 down to pH 4. The data in the table also shows that at least where the blowing agents are dual melted into the top layer at the coating point, increasingly smooth surfaces are obtained by reducing the pH of the melt to pH 5, to pH 4 and to pH 2 from pH 6.

It will be understood by those skilled in the art that the invention is not limited to use with bead coating. Any conventional coating method may be used.

The invention has been described in detail with reference to preferred embodiments thereof. It will be understood by those skilled in the art that variations and modifications can be effected within the scope of the invention.

1. A method of making a material comprising the steps of coating a support with at least one layer of polymer solution containing a surfactant, and at least one blowing agent, the pH value of the at least one layer of solution being reduced prior to the addition of the at least one blowing agent.

2. A method as claimed in claim 1 wherein the pH value is reduced to a value of pH 5 or below.

3. A method as claimed in claim 2 wherein the pH value is reduced to a value of pH 4 or below.

4. A method as claimed in claim 3 wherein the pH value is reduced to a value in the range of pH 2 to pH 4.

5. A method as claimed in claim 1 wherein the pH value of the solution is reduced by the addition of acid.

6. A method as claimed in claim 5 wherein the acid added is sulphuric acid.

7. A method as claimed in claim 1 wherein the at least one blowing agent is dual melted into a layer of solution prior to coating.

8. A method as claimed in claim 1 wherein the at least one blowing agent is added directly to the solution.

9. (canceled)

9. An inkjet recording medium formed by the method of claim 1.
